(19) United States
(12) Patent Application Publication
(10) Pub. No.: US 2006/0162482 A1
(43) Pub. Date: Jul. 27, 2006

(54) Bicycle stem

(75) Inventors: Shinpei Okajima, Izumi City (JP); Takeshi Yoshimatsu, Izumi City (JP)

Correspondence Address: GLOBAL IP COUNSELORS, LLP, 1233 20TH STREET, NW, SUITE 700, WASHINGTON, DC, 20036-2680, US

(73) Assignee: Shimano Inc., Sakai (JP)

(21) Appl. No.: 11/033,126

(22) Filed: Jan. 12, 2005

(51) Int. Cl. B62K 21/12

(52) U.S. Cl. 74/551.1

(57) ABSTRACT

A bicycle stem is described that includes steering column clamping end portion, a hollow tubular portion and handlebar clamping end portion. The steering column clamping end portion is configured to be coupled to a bicycle steering column. The hollow tubular portion extends from the steering column clamping end portion to the handlebar clamping end portion. The handlebar clamping end portion is configured to be coupled to a bicycle handlebar. The handlebar clamping end portion includes two horizontally aligned first handlebar abutment surfaces that are laterally spaced apart relative to a center axis of the hollow tubular portion. The handlebar clamping end portion also includes a first arc shaped wall section extending between the first handlebar abutment surfaces with the first arc shaped wall section having a first convex exterior surface and a first concaved interior surface.

### BACKGROUND OF THE INVENTION

1. Field of the Invention

This invention generally relates to a bicycle stem that includes at least one arcuate wall that extends between a pair of handlebar abutment surfaces. More specifically, the present invention relates to a bicycle stem having a handlebar clamping end that includes at least one arcuate wall between pairs of handlebar abutment surfaces, the arcuate wall having an outer convex surface and an inner concave surface.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle as well as the frame of the bicycle. One goal of such redesigns is to reduce the overall weight of both street and off road mountain bicycles to make them lighter and more competitive.

One component that has been extensively redesigned is the bicycle stem. For example, various bicycle stems have been proposed in recent years that include alternative geometries and hollow interiors (see U.S. Pat. Nos. 6,343,891 and 5,299,467). However, the prior art does not address weight reductions in bicycle stems to reduce the overall weight of bicycles.

In view of the above, it will be apparent to those skilled in the art from this disclosure that there exists a need for an improved bicycle stem. This invention addresses this need in the art as well as other needs, which will become apparent to those skilled in the art from this disclosure.

### SUMMARY OF THE INVENTION

One object of the present invention is to provide a bicycle stem with structural features that provide strength and durability.

Another object of the present invention is to provide a bicycle stem that has reduced mass and is therefore lightweight.

The foregoing objects can basically be attained by providing a bicycle stem that basically comprises a steering column clamping end portion, a hollow tubular portion and a handlebar clamping end portion. The steering column clamping end portion is configured to be coupled to a bicycle steering column. The hollow tubular portion extends from the steering column clamping end portion. The handlebar clamping end portion is positioned at an end opposite the steering column clamping end portion relative to the hollow tubular portion. The handlebar clamping end portion is configured to be coupled to a bicycle handlebar. The handlebar clamping end portion includes two horizontally aligned first handlebar abutment surfaces that are laterally spaced apart relative to a center axis of the hollow tubular portion and a first arc shaped wall section extending between the first handlebar abutment surfaces with the first arc shaped wall section having a first convex exterior surface and a first concaved interior surface.

These and other objects, features, aspects and advantages of the present invention will become apparent to those skilled in the art from the following detailed description, which, taken in conjunction with the annexed drawings, discloses a preferred embodiment of the present invention.

### BRIEF DESCRIPTION OF THE DRAWINGS

Referring now to the attached drawings which form a part of this original disclosure:

FIG. 1 is a side elevational view of a bicycle equipped with a bicycle stem in accordance with a first embodiment of the present invention;

FIG. 2 is an enlarged side elevational view of an upper portion of the bicycle depicted in FIG. 1, showing a portion of a bicycle frame, a bicycle steering column, the bicycle stem and a handlebar in accordance with the present invention;

FIG. 3 is a perspective view of the bicycle stem, shown removed from the bicycle, in accordance with a first embodiment of the present invention;

FIG. 4 is a top plan view of the bicycle stem depicted in FIG. 3, in accordance with the present invention;

FIG. 5 is a side elevation of the bicycle stem depicted in FIGS. 3-4, in accordance with the present invention;

FIG. 6 is a cross-sectional view of the bicycle stem taken along the line 6-6 in FIG. 4, in accordance with the present invention;

FIG. 7 is a cross-sectional view of the bicycle stem taken along the line 7-7 in FIG. 5, in accordance with the present invention;

FIG. 8 is a front view of the bicycle stem depicted in FIG. 3 showing a handle bar attachment portion end of the bicycle stem with a clamping end cap installed, in accordance with the present invention;

FIG. 9 is front view of the bicycle stem similar to FIG. 8, again showing the handle bar attachment portion end of the bicycle stem but with the clamping end cap removed to show further detail, in accordance with the present invention;

FIG. 10 is a side plan view of the bicycle stem similar to FIG. 5, on an enlarged, showing details of a handlebar clamping end portion, in accordance with the present invention;

FIG. 11 is a perspective view showing the clamping end cap depicted in FIGS. 3, 4 and 5, in accordance with the present invention;

FIG. 12 is a perspective view of inner surfaces of the clamping end cap depicted in FIG. 11, in accordance with the present invention;

FIG. 13 is a perspective view similar to FIG. 3, showing a bicycle stem with a clamping end cap removed, in accordance with a second embodiment of the present invention;

FIG. 14 is a perspective view showing the clamping end cap of the bicycle stem depicted in FIG. 13, in accordance with the second embodiment of the present invention; and

FIG. 15 is a perspective view of inner surfaces of the clamping end cap depicted in FIG. 14, in accordance with the second embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

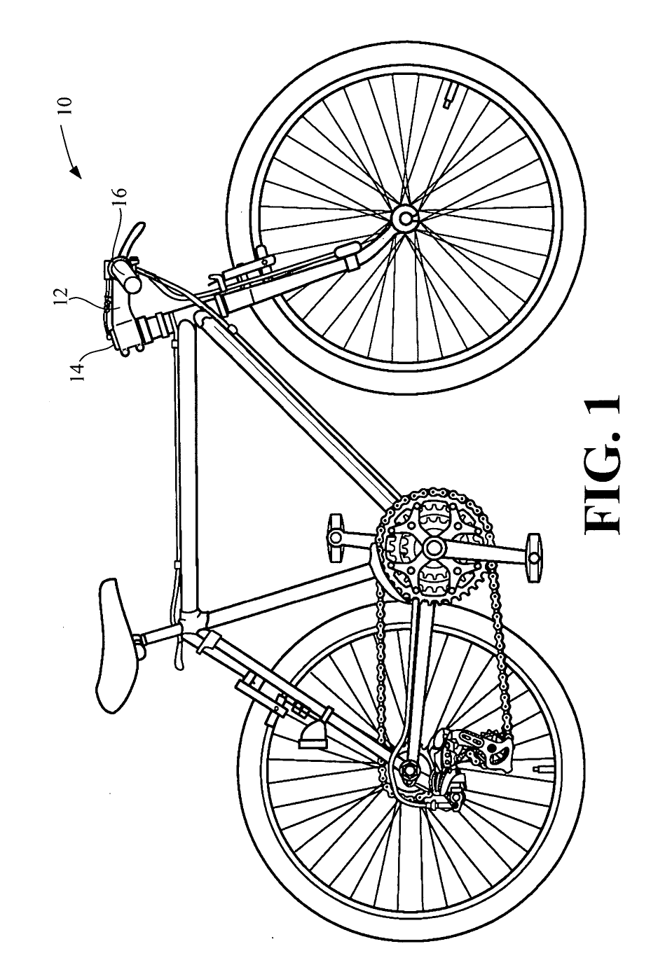

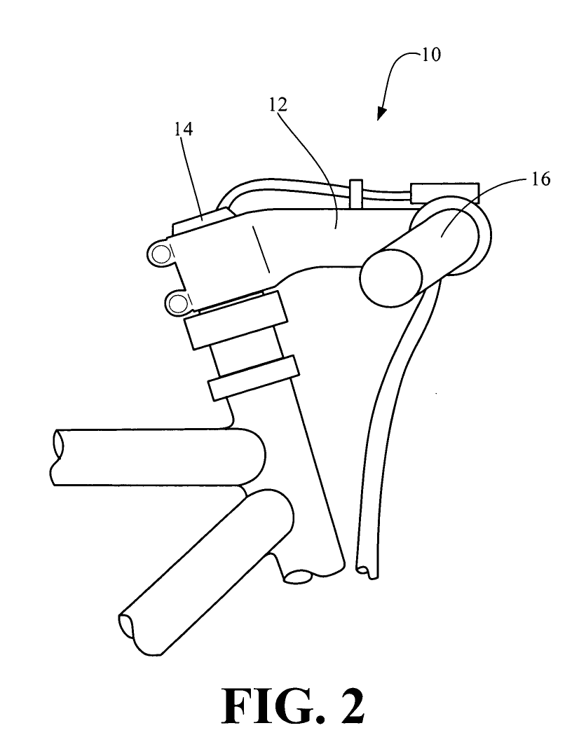

Referring initially to FIGS. 1 and 2, a bicycle 10 is illustrated equipped with a bicycle stem 12 in accordance with a first embodiment of the present invention. The bicycle stem 12 interconnects a bicycle steerer tube or steering column 14 to a handlebar 16.

Bicycles and their various components are well known in the art, and thus, bicycle 10 and its various components will not be discussed and/or illustrated in detail herein, except for the components that relate to the bicycle stem 12 of the present invention. Also as used herein, the following directional terms “forward, rearward, above, downward, vertical, horizontal, below and transverse” as well as any other similar directional terms refer to those directions of a bicycle equipped with the bicycle stem 12 of the present invention. Accordingly, these terms, as utilized to describe the present invention should be interpreted relative to a bicycle equipped with the bicycle stem 12 of the present invention.

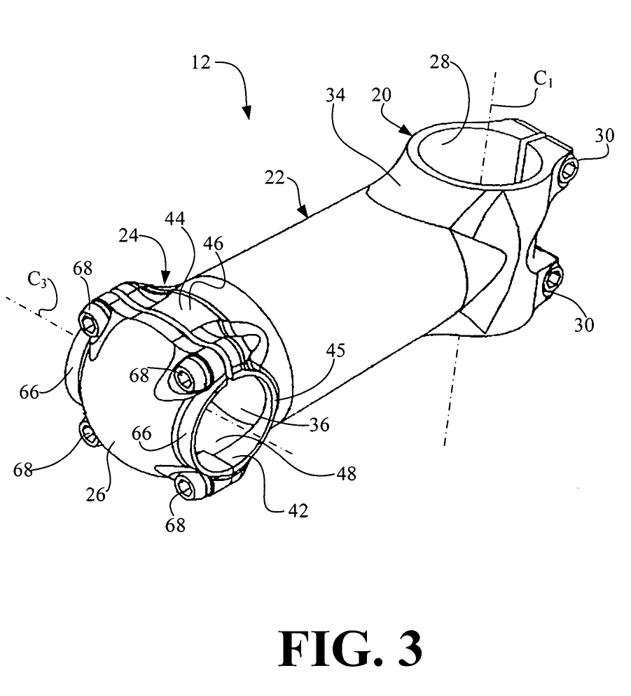

As shown in FIG. 3, the bicycle stem 12 basically includes a steering column clamping end portion 20, a hollow tubular portion 22 and a handlebar clamping end portion 24 with a clamping end cap 26. The hollow tubular portion 22 extends between the steering column clamping end portion 20 and the handlebar clamping end portion 24. Thus, the handlebar clamping end portion 24 is coupled to the hollow tubular portion 22 at an end opposite the steering column clamping end portion 20. It should be understood from the drawings and the description herein that the various portions of the bicycle stem 12 can be formed unitarily as a single structure. Alternatively, the various portions of the bicycle stem 12 can be formed separately and welded together to form the bicycle stem 12 of the present invention.

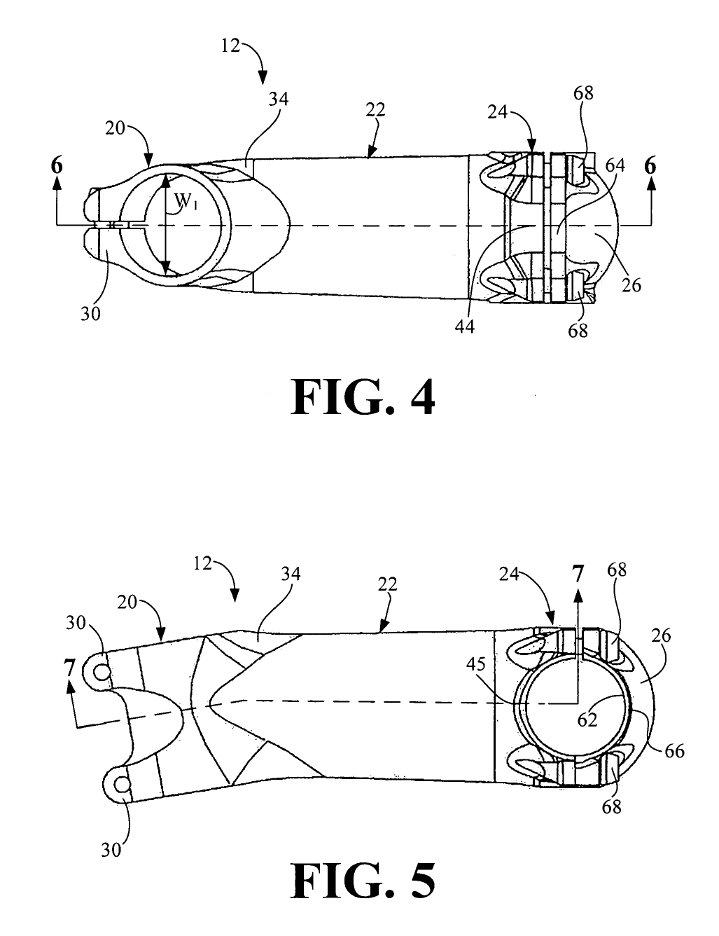

The steering column clamping end portion 20 is now described in greater detail. The steering column clamping end portion 20 is configured to be coupled to the steering column 14. With reference to FIGS. 3, 4, 5 6, 7 and 9, the steering column clamping end portion 20 basically includes a steering column receiving bore 28 and two bolt clamping sections 30.

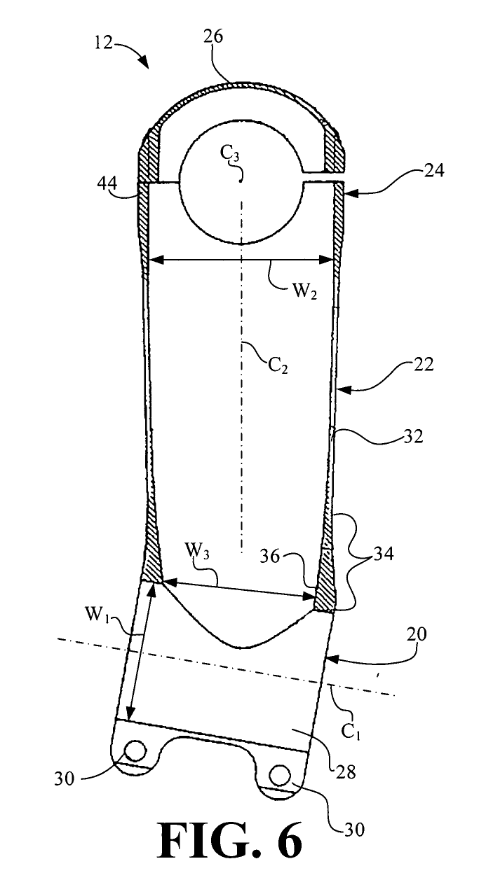

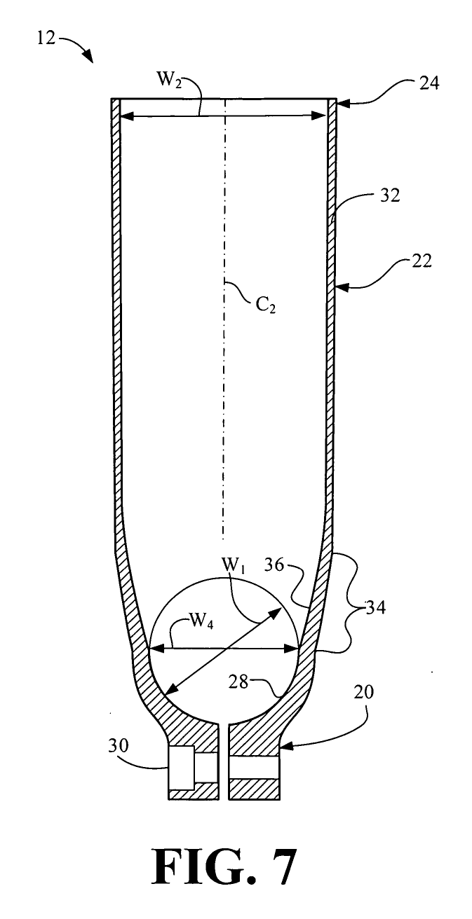

The steering column receiving bore 28 defines a central axis C₁ and has a maximum inner width W₁, as shown in FIG. 6. The steering column receiving bore 28 is dimensioned to receive the steering column 14 in alignment with the central axis C₁. As shown in FIGS. 3, 5, 6 and 7, the two bolt clamping sections 30 provide a means for tightening the steering column clamping end portion 20 around the steering column 14.

The hollow tubular portion 22 is now described with specific reference to FIGS. 6, 7 and 9. The hollow tubular portion 22 is hollow along its entire length and is basically formed with an elongated, relatively thin encompassing wall 32 and a tapered section 34. The thin encompassing wall 32 defines a central axis C₂ that extends the longitudinal length of the hollow tubular portion 22.

The thin encompassing wall 32 of the hollow tubular portion 22 is formed with an interior maximum width W₂, as shown in FIGS. 6, 7 and 9. Except for the tapered section 34, the hollow tubular portion 22 can be formed with a constant width or can be formed with a slight taper. Specifically, the thin encompassing wall 32 of the hollow tubular portion 22 has an interior width that becomes slightly larger as the hollow tubular portion 22 extends from the tapered section 34 to the handlebar clamping end portion 24. As shown in cross-section in FIG. 6, the thin encompassing wall 32 has sufficient thickness to provide strength to the bicycle stem 12, but is sufficiently thin to be lightweight.

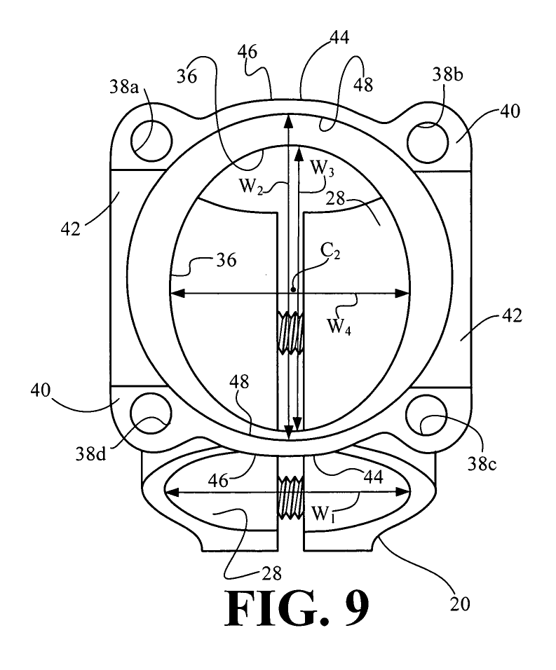

The tapered section 34 couples the steering column clamping end portion 20 to the hollow tubular portion 22. The tapered section 34 basically includes a wall portion 36 that extends from the thin encompassing wall 32. The wall portion 36 is slightly thicker than the thin encompassing wall 32 to provide transitional strength to the bicycle stem 12. An inner surface of the wall portion 36 of the tapered section 34 has an elliptical shape with a maximum inner width W₃, and a minimum inner width W₄, shown in FIG. 9. The minimum inner width W₄ is smaller than the interior maximum width W₃. As is further indicated in FIG. 9, the minimum inner width W₄ of the tapered section 34 is smaller than the interior maximum width W₂ of the hollow tubular portion 22. Further the maximum inner width W₁ of the steering column receiving bore 28 is also smaller than the interior maximum width W₂ of the hollow tubular portion 22.

As is shown in FIG. 6, the central axis C₁ of the steering column clamping end portion 20 is not perpendicular to the central axis C₂ of the hollow tubular portion 22. Rather, there is an angular offset between the hollow tubular portion 22 and the steering column clamping end portion 20. As a result, the hollow tubular portion 22 is positioned in a generally horizontal orientation, as shown in FIGS. 1 and 2.

As should be understood from FIG. 9, the hollow interior of the hollow tubular portion 22 extends to the steering column receiving bore 28. Specifically, as shown in FIG. 9 with the clamping end cap 26 removed, the steering column receiving bore 28 is visible through the hollow tubular portion 22.

The handlebar clamping end portion 24 is now described with specific reference to FIGS. 3, 4, 5, 9 and 10. The handlebar clamping end portion 24 is configured to be coupled to the bicycle handlebar 16. The handlebar clamping end portion 24 basically includes threaded bolt holes 38a, 38b, 38c and 38d, two cap abutment surfaces 40, a pair of handlebar contact surfaces 42, two arc shaped wall sections 44, brim sections 45 and the clamping end cap 26. The handlebar clamping end portion 24 in combination with the clamping end cap 26 defines a central handlebar axis C₃, as shown in FIGS. 3 and 6.

The threaded bolt holes 38a, 38b, 38c and 38d are approximately equally spaced apart from one another in horizontal and vertical directions, as shown in FIG. 9. Further, the threaded bolt holes 38a, 38b, 38c and 38d are approximately equidistantly spaced apart from the central axis C₂ of the hollow tubular portion 22 and the central handlebar axis C₃. The threaded bolt holes 38a, 38b, 38c and 38d are also generally parallel to one another and parallel to the central axis C₂ of the hollow tubular portion 22.

The two cap abutment surfaces 40 are co-planar surfaces that are generally parallel to one another on opposite sides of the central axis C₂ of the hollow tubular portion 22 and opposite sides of the central handlebar axis C₃. The threaded bolt holes 38a and 38b are formed in one of the two cap abutment surfaces 40, and the threaded bolt holes 38c and 38d are formed in the other of the two cap abutment surfaces 40.

The handlebar contact surfaces 42 are arcuate or semi-circular shaped surfaces configured and arranged for engagement with the handlebar 16. The handlebar contact surfaces 42 are aligned and have an approximate center coinciding with central handlebar axis C₃. A first of the handlebar contact surfaces 42 extends proximately between threaded bolt holes 38a and 38d, and a second of the handlebar contact surfaces 42 extends proximately between bolt holes 38b and 38c.

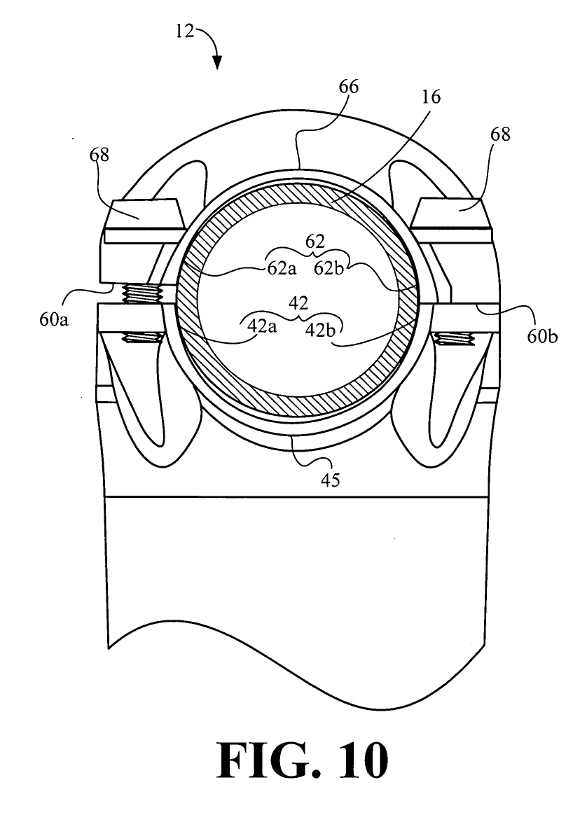

As stated above, each of the handlebar contact surfaces 42 can be semi-circular in shape. Preferably, the handlebar contact surfaces 42 can have a slightly elliptical shape to more readily allow for flexing of the handlebar clamping end portion 24 when attached to the handlebar 16. As shown more clearly in FIG. 10, each handlebar abutment surface 42 includes two handlebar abutment surface sections 42a and 42b that initially contact the handlebar 16. It should be understood that once tightened and fixed in place, the handlebar clamping end portion 22 can flex and most or all of the handlebar abutment surface 42 can contact the outer periphery of the handlebar 16.

As shown in FIG. 9, the two arc shaped wall sections 44 are arcuate contoured sections that extend proximately between corresponding pairs of the threaded bolt holes. Specifically, the first of the arc shaped wall sections 44 extends proximately between threaded bolt holes 38a and 38b, and a second of the arc shaped wall sections 44 extends proximately between threaded bolt holes 38c and 38d. The arc shaped wall sections 44 are laterally spaced apart from one another on opposite sides of the central handlebar axis C₃ and the central axis C₂. As shown in FIGS. 3 and 9, each of the arc shaped wall sections 44 has an outer convex exterior surface 46 and a concaved interior surface 48. As well, the arc shaped wall sections 44 each have a generally uniform thickness.

As can be seen in FIG. 9, each of the arc shaped wall sections 44 extends proximately between corresponding ends of the handlebar abutment surfaces 42. Consequently, the arc shaped wall sections 44 extend in directions that are generally perpendicular to the extending direction of the handlebar abutment surfaces 42. Since the arc shaped wall sections 44 have an arcuate shape, they provide strength and stability to the bicycle stem 12 while fixed to the handlebar 16 in spite of the fact that the thickness of the arc shaped wall section 44 is relatively thin. Accordingly, inclusion of such an arc shaped wall section 44 can result in achieving effective weight reduction for a bicycle stem.

The handlebar clamping end portion 24 is also formed with two generally identical brim sections 45, shown in FIGS. 3, 5 and 10. Each brim section 45 has an arcuate or semi-circular shape with a uniform thickness. Each brim section 45 is basically a re-enforcing wall that provides additional strength to the handlebar clamping end portion 24. The handlebar abutment surfaces 42 are at least partially formed on the inner portion of the brim sections 45. Inclusion of the brim sections 45 allows the handlebar abutment surfaces 42 to have additional width and consequently more surface area for contacting the handlebar 16. Specifically, the brim sections 45 absorb and distribute undesirable stress-concentrations that sometimes occur at the edges of the handlebar abutment surfaces 42.

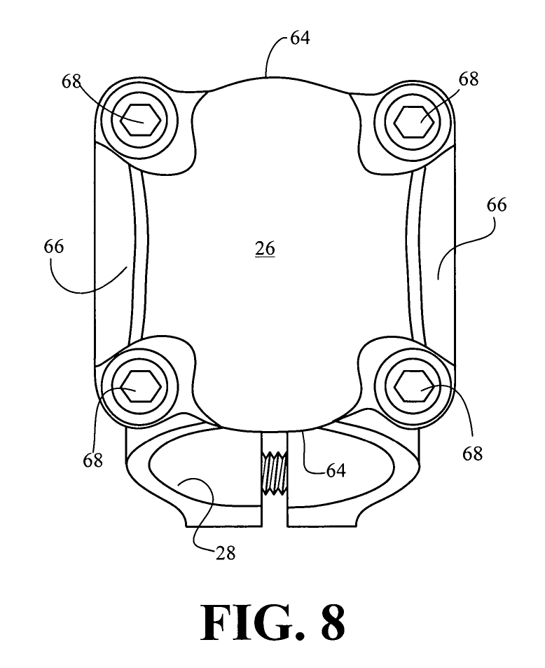

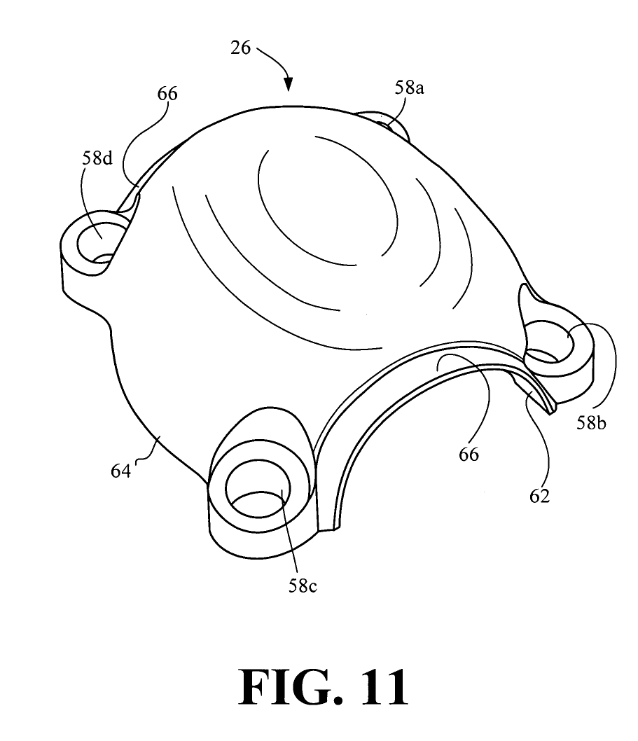

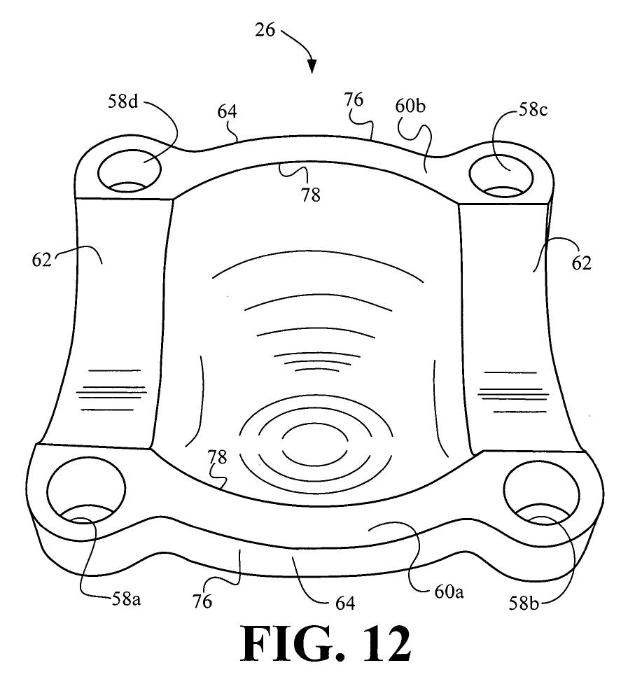

The clamping end cap is now described with specific reference to FIGS. 8, 10, 11 and 12. The clamping end cap 26 is a removable clamping cap section of the handlebar clamping end portion 24. The clamping end cap 26 is configured to be attached to the handlebar clamping end portion 24 thereby wrapping around and securing the bicycle handlebar 16. As shown more clearly in FIGS. 11 and 12, the clamping end cap 26 includes bolt holes 58a, 58b, 58c and 58d, two end abutment surfaces 60a and 60b, a pair of handlebar contact surfaces 62, two arc shaped wall sections 64 and two brims 66. The clamping end cap 26 is generally thin walled throughout and has a hollow interior, as seen in FIG. 12.

Referring to FIGS. 6, 8, 9, 11 and 12, the bolt holes 58a, 58b, 58c and 58d are approximately equally spaced apart from one another in horizontal and vertical directions. Further, the bolt holes 58a, 58b, 58c and 58d are approximately equidistantly spaced apart from the central axis C₂ of the hollow tubular portion 22 and the central handlebar axis C₃. The bolt holes 58a, 58b, 58c and 58d are also aligned with the threaded bolt holes 38a, 38b, 38c and 38d in the handlebar clamping end portion 24. The bolt holes 58a, 58b, 58c and 58d are also generally parallel to one another and parallel to the central axis C₂ of the hollow tubular portion 22. Bolts 68 are installed in the bolt holes 58a, 58b, 58c and 58d and the threaded bolt holes 38a, 38b, 38c and 38d to retain the clamping end cap 26 on the handlebar clamping end portion 24 and retain the handlebar 16 in position.

The two end abutment surfaces 60a and 60b are surfaces that are generally parallel to one another on opposite sides of the central axis C₂ of the hollow tubular portion 22 and opposite sides of opposite sides of the central handlebar axis C₃. The bolt holes 58a and 58b are formed in the two end abutment surfaces 60a, and the bolt holes 58c and 58d are formed in the two end abutment surfaces 60b.

The cap abutment surfaces 60a and 60b are preferably not co-planar, but rather are offset from one another, as shown in FIG. 10. Specifically, with the bolts 68 finger tightened in respective bolt holes, the end abutment surface 60b is in contact with the corresponding cap abutment surface 40 on the handlebar clamping end portion 24. However, with the bolts 68 finger tightened, the end abutment surface 60a is spaced apart from its corresponding cap abutment surface 40 on the handlebar clamping end portion 24. As a result, the bolts 68 can be further tightened with a tool (not shown) causing slight flexing in the handlebar clamping end portion 24 and the clamping end cap 26 to ensure a firm clamping grip on the handlebar 16.

The handlebar contact surfaces 62 are arcuate or semi-circular shaped surfaces configured and arranged for engagement with the handlebar 16. The handlebar contact surfaces 62 are aligned with one another and have an approximate center coinciding with central handlebar axis C₃. A first of the handlebar contact surfaces 62 extends proximately between the bolt holes 58a and 58d, and a second of the handlebar contact surfaces 62 extends proximately between bolt holes 58b and 58c.

As stated above, each of the handlebar contact surfaces 62 can be semi-circular in shape. Preferably, the handlebar contact surfaces 62 can have a slightly elliptical shape to more readily allow for flexing of the handlebar clamping end portion 24 while attaching to the handlebar 16. As shown more clearly in FIG. 10, each handlebar abutment surface 62 includes two handlebar abutment surface sections 62a and 62b that contact the handlebar 16. It should be understood that once fixed in place, the clamping end cap 26 flexes and most or all of the handlebar abutment surface 62 can contact the outer periphery of the handlebar 16.

As shown in FIG. 12, the two arc shaped wall sections 64 are arcuate contoured sections that extend between corresponding pairs of the bolt holes. Specifically, the first of the arc shaped wall sections 64 extends between the bolt holes 58a and 58b, and a second of the arc shaped wall sections 64 extends between the bolt holes 58c and 58d. The arc shaped wall sections 64 are laterally spaced apart from one another on opposite sides of the central handlebar axis C₃. Each of the arc shaped wall sections 64 has an outer convex exterior surface 76 and a concaved interior surface 78. As well, the arc shaped wall sections 64 each have a generally uniform thickness.

As can be seen in FIG. 12, each of the arc shaped wall sections 64 extends between adjacent ends of the handlebar abutment surfaces 62. Consequently, the arc shaped wall sections 64 extend in directions that are generally perpendicular to the extending direction of the handlebar abutment surfaces 62. Since the arc shaped wall sections 64 have an arcuate shape, they provide strength and stability to the bicycle stem 12 while fixed to the handlebar 16 in spite of the fact that the thickness of the arc shaped wall section 64 is relatively thin. Accordingly, inclusion of such an arc shaped wall section 64 can result in achieving effective weight reduction for a bicycle stem.

Referring now to FIGS. 3, 5, 10 and 11, the clamping end cap 26 is also formed with two brims 66. Each brim 66 has an arcuate or semi-circular shape with a uniform thickness. Each brim 66 is basically a re-enforcing wall that provides additional strength to the clamping end cap 26. The handlebar abutment surfaces 62 are at least partially formed on the inner portion of the brims 66. Inclusion of the brims 66 allows the handlebar abutment surfaces 62 to have additional width and consequently more surface area for contacting the handlebar 16. Specifically, the brims 66 absorb and distribute undesirable stress-concentrations that sometimes occur at the edges of the handlebar abutment surfaces 62.

As indicated in FIGS. 3, 5 and 10, the brim sections 45 of the handlebar clamping end portion 24 and the brims 66 of clamping end cap 26 together form an almost continuous annular ring around the handlebar 16.

### Second Embodiment

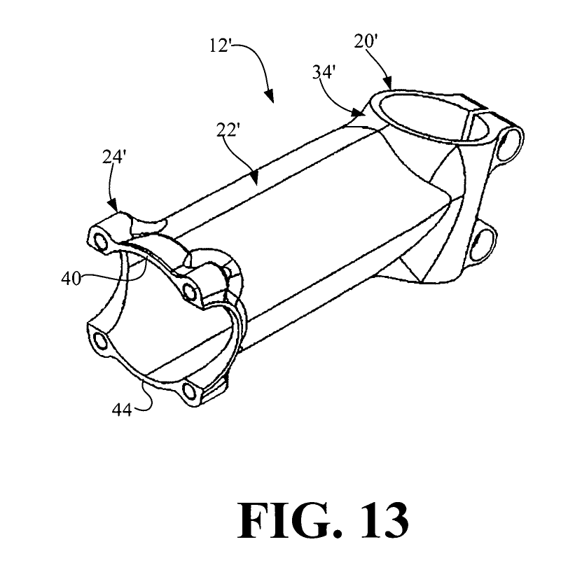

Referring now to FIGS. 13, 14 and 15, a bicycle stem 12′ in accordance with a second embodiment will now be explained. In view of the similarity between the first and second embodiments, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

The bicycle stem 12′ basically includes a steering column clamping end portion 20′, a hollow tubular portion 22′ and a handlebar clamping end portion 24′ with a clamping cap 126. The steering column clamping end portion 20′ is generally the same as the steering column clamping end portion 20 of the first embodiment. The hollow tubular portion 22′ is generally the same as the hollow tubular portion 22 of the first embodiment, except that the tapered section 34′ in the second embodiment is not as pronounced. Further, in the second embodiment, the hollow tubular portion 22′ can have a less rounded cross-section. The handlebar clamping end portion 24′ is also very similar to that described above in the first embodiment and includes the arc shaped wall sections 44.

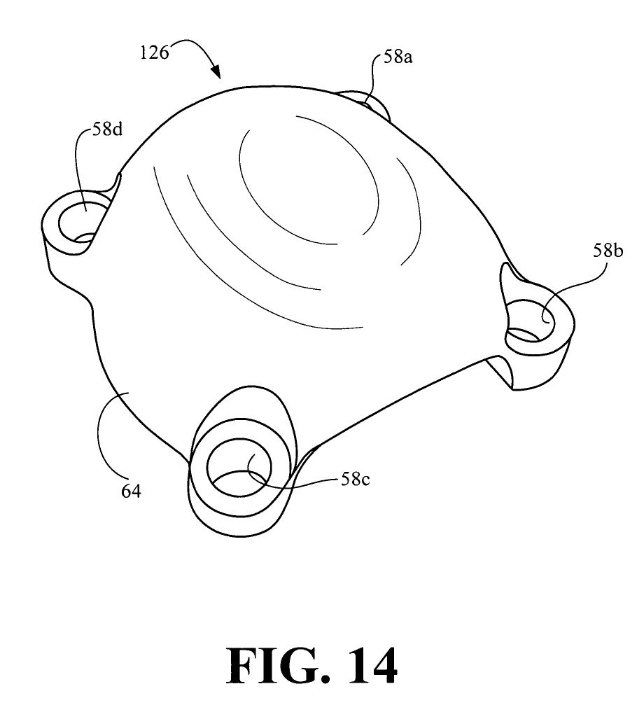

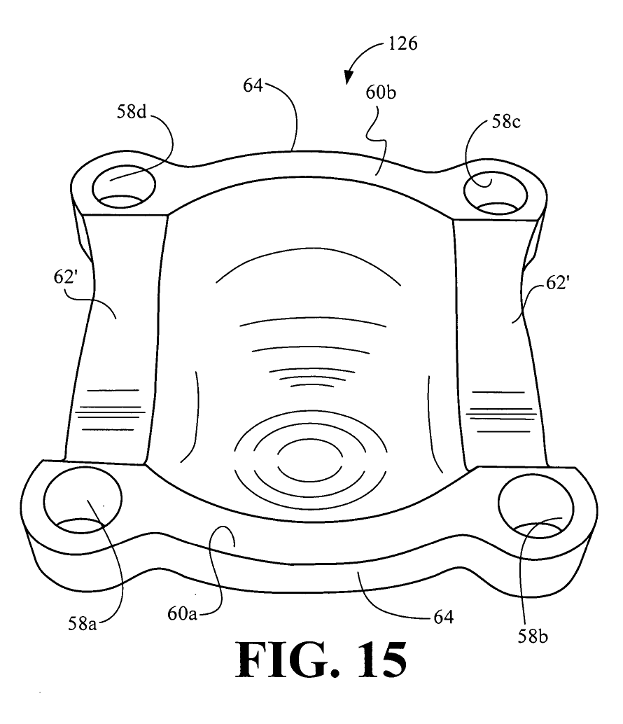

A more pronounced difference between the first and second embodiments is found in the clamping cap 126, shown in FIGS. 14 and 15.

Like the first embodiment, the clamping cap 126 is a removable clamping cap section of the handlebar clamping end portion 24′. The clamping cap 126 includes the bolt holes 58a, 58b, 58c and 58d, two end abutment surfaces 60a and 60b, a pair of handlebar contact surfaces 62′ and two arc shaped wall sections 64. However the clamping cap 126 does not include brims. The handlebar contact surfaces 62′ are not as wide throughout their arcuate length as the corresponding surfaces in the first embodiment due to the missing brims. However, in most other respects the clamping cap 126 has generally the same features as the clamping end cap 26 of the first embodiment without the brims.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “member” or “element” when used in the singular can have the dual meaning of a single part or a plurality of parts. Finally, terms of degree such as “substantially”, “about” and “approximately” as used herein mean a reasonable amount of deviation of the modified term such that the end result is not significantly changed. These terms of degree should be construed as including a deviation of at least +5% of the modified term if this deviation would not negate the meaning of the word it modifies.

While only selected embodiments have been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle stem comprising:
a steering column clamping end portion configured to be coupled to a bicycle steering column;
a hollow tubular portion extending from the steering column clamping end portion; and
a handlebar clamping end portion positioned at an end opposite the steering column clamping end portion relative to the hollow tubular portion,
the handlebar clamping end portion being configured to be coupled to a bicycle handlebar, the handlebar clamping end portion including two horizontally aligned first handlebar abutment surfaces that are laterally spaced apart relative to a center axis of the hollow tubular portion and a first arc shaped wall section extending between the first handlebar abutment surfaces with the first arc shaped wall section having a first convex exterior surface and a first concaved interior surface.

2. The bicycle stem as set forth in claim 1, wherein
the steering column clamping end portion is configured to define a steering column receiving bore having a maximum inner width that is smaller than an interior maximum width of the hollow tubular portion.

3. The bicycle stem as set forth in claim 1, wherein
the hollow tubular portion and the steering column clamping end portion are interconnected by a tapered section.

4. The bicycle stem as set forth in claim 1, wherein
a threaded bore is located adjacent each of the first handlebar abutment surfaces with the threaded bores extending generally parallel to the center axis of the hollow tubular portion.

5. The bicycle stem as set forth in claim 1, wherein
the handlebar clamping end portion has a pair of curved brims located laterally and outwardly of the first handlebar abutment surfaces.

6. The bicycle stem as set forth in claim 1, wherein
the handlebar clamping end portion further includes two horizontally aligned second handlebar abutment surfaces that are laterally spaced apart relative to a center axis of the hollow tubular portion and a second arc shaped wall section extending between the second handlebar abutment surfaces with the second arc shaped wall section having a second convex exterior surface and a second concaved interior surface.

7. The bicycle stem as set forth in claim 6, wherein
the steering column clamping end portion is configured to define a steering column receiving bore having a maximum inner width that is smaller than an interior maximum width of the hollow tubular portion.

8. The bicycle stem as set forth in claim 6, wherein
the hollow tubular portion and the steering column clamping end portion are interconnected by a tapered section.

9. The bicycle stem as set forth in claim 6, wherein
a threaded bore is located adjacent each of the handlebar abutment surfaces with the threaded bores extending generally parallel to the center axis of the hollow tubular portion.

10. The bicycle stem as set forth in claim 6, wherein
the handlebar clamping end portion further includes a pair of curved brims located laterally and outwardly of the first and second handlebar abutment surfaces.

11. The bicycle stem as set forth in claim 6, wherein
the hollow tubular portion tapers in a longitudinal direction such that an interior maximum width of the hollow tubular portion becomes progressively larger as the hollow tubular portion extends from the steering column clamping end portion to the handlebar clamping end portion.

12. The bicycle stem as set forth in claim 6, wherein
a first pair of the first and second handlebar abutment surfaces form part of a first semi-circular shaped handlebar contact surface, and a second pair of the first and second handlebar abutment surfaces form part of a second semi-circular shaped handlebar contact surface.

13. The bicycle stem as set forth in claim 1, wherein
the handlebar clamping end portion further includes a removable clamping cap section coupled by fasteners to threaded bores located adjacent the first handlebar abutment surfaces.

14. The bicycle stem as set forth in claim 1, wherein
the first arc shaped wall section has a substantially uniform wall thickness between the first handlebar abutment surfaces.

15. A bicycle stem comprising:
a steering column clamping end portion configured to be coupled to a bicycle steering column;
a hollow tubular portion extending from the steering column clamping end portion; and
a handlebar clamping end portion positioned at an end opposite the steering column clamping end portion relative to the hollow tubular portion,
the handlebar clamping end portion being configured to be coupled to a bicycle handlebar, the handlebar clamping end portion including two horizontally aligned first fastener attachment sections that are laterally spaced apart relative to a center axis of the hollow tubular portion and a first arc shaped wall section extending between the first fastener attachment sections with the first arc shaped wall section having a first convex exterior surface and a first concaved interior surface.

16. The bicycle stem as set forth in claim 15, wherein
the steering column clamping end portion is configured to define a steering column receiving bore having a maximum inner width that is smaller than an interior maximum width of the hollow tubular portion.

17. The bicycle stem as set forth in claim 15, wherein
the hollow tubular portion and the steering column clamping end portion are interconnected by a tapered portion.

18. The bicycle stem as set forth in claim 15, wherein
a threaded bore is located in each of the fastener attachment sections with the threaded bores extending generally parallel to the center axis of the hollow tubular portion.

19. The bicycle stem as set forth in claim 15, wherein
the handlebar clamping end portion has a pair of curved brims located laterally and outwardly of the fastener attachment sections.

20. The bicycle stem as set forth in claim 15, wherein
the handlebar clamping end portion further includes two horizontally aligned second fastener attachment sections that are laterally spaced apart relative to a center axis of the hollow tubular portion and a second arc shaped wall section extending between the second fastener attachment sections with the second arc shaped wall section having a second convex exterior surface and a second concaved interior surface.
